(19) United States
(12) Patent Application Publication
(10) Pub. No.: US 2024/0011454 A1
(43) Pub. Date: Jan. 11, 2024

(54) EXHAUST GAS RECIRCULATION VALVE DIAGNOSTICS

(71) Applicant: International Engine Intellectual Property Company, LLC, Lisle, IL (US)

(72) Inventor: Timothy M. Lyons, Batavia, IL (US)

(73) Assignee: International Engine Intellectual Property Company, LLC, Lisle, IL (US)

(21) Appl. No.: 17/859,583

(22) Filed: Jul. 7, 2022

(51) Int. Cl. F02M 26/49; F02M 26/48

(52) U.S. Cl. CPC F02M 26/49; F02M 26/48

(57) ABSTRACT

A method of monitoring an exhaust system of an engine having an engine control unit including a diagnostic module operatively associated with the engine comprises providing an exhaust gas recirculation valve connected with the engine control unit within the exhaust system. Position of the exhaust gas recirculation valve is automatically monitored during operation of the engine. Position of the exhaust gas recirculation valve is determined. Determined position of the exhaust gas recirculation valve is transmitted to the diagnostic module.

### TECHNICAL FIELD

The present disclosure relates to a system and a method for use in connection with an exhaust system of an engine. Specifically, the present disclosure relates to improved diagnostic system and method for monitoring status of an exhaust gas recirculation (EGR) valve in the exhaust system of an engine, including using comparison calibration values to monitor wear and function of the EGR valve to reduce failure or other potential malfunction of the exhaust system. The present diagnostic system and method are configured to pinpoint cause of EGR valve issues and/or failures before they become significant by providing an accurate diagnosis for initiation of repair.

### BACKGROUND

The Exhaust Gas Recirculation or EGR system is one of several engine emission control systems for use in connection with a variety of engines including diesel engines. The EGR system recirculates a part of the exhaust gas back into engine cylinders through combustion chambers which helps to provide cleaner vehicle exhaust by reducing nitrogen oxides (NOx) in the exhaust gases. Nitrogen oxides are formed in process of combustion in the engine cylinders when atmospheric nitrogen gas is exposed to high temperatures in combustion chambers.

Integral to an engine management system of a vehicle for controlling emissions is the exhaust gas recirculation (EGR) valve. The EGR valve recirculates finely metered quantities of exhaust gas to an engine intake system for lower NOx emissions. The EGR valve is an increasingly important component of the vehicle engine exhaust system due to growing pressure to reduce emissions and greenhouse gases across all sectors of machinery utilizing exhaust systems, including passenger vehicles and diesel engines.

Maintenance of the exhaust system is critical not only for proper operation of the vehicle, but also to reduce emissions. EGR valve can experience wear and tear over time or be subject to carbon buildup from the exhaust gases which may cause the EGR valve to stick in a given state or position, i.e. open or closed. In some engines, the EGR valve is a “smart” device which can self-diagnose and report malfunction to an engine control unit (ECU). However, during operations where the EGR valve is commanded dosed by the ECU, self diagnostics may not report that an EGR valve is inoperable and unable to maintain a closed position. Repetitive opening and closing of the EGR valve can lead to a point where the exhaust pressure against the EGR valve exceeds ability of the EGR valve to remain closed, leading to failure of the exhaust system including potentially the failure of downstream components of the exhaust system, such as an EGR cooler. Having ability to monitor the EGR valve positions, particularly during certain engine operation conditions when the EGR valve is commanded closed but is unable to do so, would potentially reduce costly failures and malfunctions of the exhaust system.

Therefore, a need exists for an improved diagnostic/monitoring system and method for use in connection with the exhaust system of a vehicle. Specifically, a need exists for an improved system and method for monitoring status of the EGR valve within the exhaust system in an engine.

A need further exists for an improved diagnostic system and method to monitor various open and closed positions of the EGR valve.

Yet another need exists for an improved diagnostic system and method wherein the ECU monitors and compares the EGR valve actual positions versus commanded positions during certain engine operating conditions and reporting those values to the ECU for diagnostic readings.

A need also exists for an improved diagnostic system and method wherein through a series of calibration values, the ECU determines if an EGR valve failure exists so an accurate diagnosis and any necessary repair can be initiated, thereby saving on engine downtime and costs.

A need also exists for an improved diagnostic system and method wherein the ECU reports potential failure of the EGR valve through a malfunction indicator lamp of a vehicle for easier diagnosis of any malfunction.

### SUMMARY

One embodiment of a method of monitoring an exhaust system of an engine having an engine control unit including a diagnostic module operatively associated with the engine comprises providing an exhaust gas recirculation valve connected with the engine control unit within the exhaust system. Position of the exhaust gas recirculation valve is automatically monitored during operation of the engine. Position of the exhaust gas recirculation valve is determined. Determined position of the exhaust gas recirculation valve is transmitted to the diagnostic module.

### BRIEF DESCRIPTION OF THE DRAWINGS

FIG. 1 is a diagram of a PRIOR ART exhaust gas recirculation system for a vehicle; and

FIG. 2 is a flow chart illustrating implementation of a diagnostic system and a method described herein.

### DETAILED DESCRIPTION

The present disclosure relates to embodiments of an improved system and method for use in connection with diagnosis and maintenance of an exhaust system of an engine, such as a diesel engine and the like. The engine has an engine control unit (ECU) including memory retaining software assisting in operation of the engine. That software comprises a diagnostic module. Specifically, the present disclosure relates to embodiments of an improved diagnostic system and method for monitoring status of an EGR valve including monitoring actual position and commanded position, i.e. open position and closed position, of the EGR valve. Some current diagnostic systems and methods pinpoint a cause of possible EGR valve failure and malfunction based on differences between an actual position of the EGR valve and the commanded position of the EGR valve thereby providing an accurate diagnosis of the EGR valve and/or premature failure of a downstream component, such as the EGR cooler and the like, of the exhaust system.

The present diagnostic system and method are useful in connection with the EGR valve utilized in the exhaust system of a vehicle or other types of machinery. During certain operating conditions, such as stationary regeneration, mass air flow trim, engine braking and the like, an engine control unit (ECU) commands the EGR valve to be in a closed position, i.e., the commanded position. However, as the EGR valve wears over time, the EGR valve may reach a condition such that exhaust pressure against the EGR valve exceeds capability of the EGR valve to remain closed. Additionally, over time, there may be a buildup of carbon particles from exhaust onto the EGR valve which may cause the EGR valve to stick in a position, either open or closed. In these instances, there is a possibility of malfunction of the EGR valve, potentially resulting in a malfunction of the exhaust system of the engine.

An EGR valve may be a “smart device” capable of self-diagnosis and reporting malfunctions to the ECU. According to the present disclosure, under certain engine operating conditions, the EGR valve is commanded closed by the ECU; however, self-diagnostics may not operate as expected when the EGR valve is physically unable to maintain a closed position due to wear, carbon particle buildup, and the like. The present diagnostic system and method may override a reading of an EGR valve that is no longer capable of maintaining a closed position. Additionally, the present diagnostic system and method utilize software and calibration value comparisons that are tailored to monitor the EGR valve under certain operating conditions that would not normally permit diagnosis of a potential failure of the EGR valve.

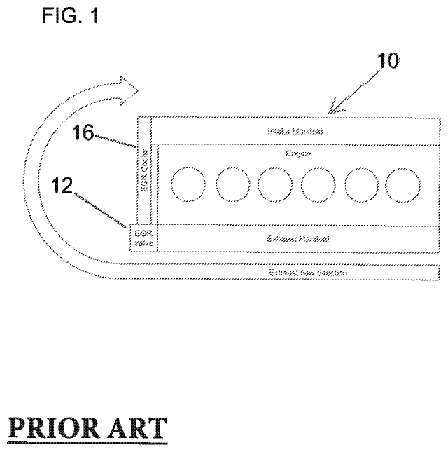

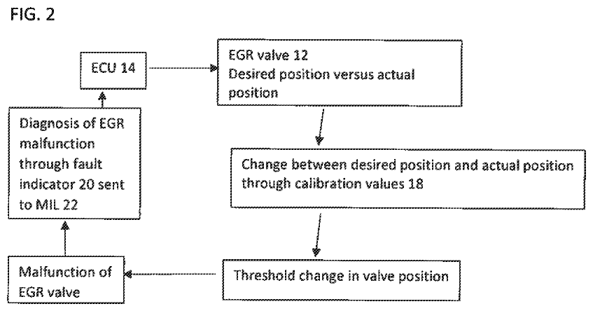

Now referring to the figures, wherein like numerals refer to like parts, FIG. 1 illustrates a diagram of a generally known exhaust system for a diesel engine incorporating an EGR valve. FIG. 2 a schematic diagram showing implementation of the present diagnostic system and method according to the present disclosure.

An exhaust system in a vehicle, including a heavy duty vehicle, a passenger vehicle and the like, are well-known. FIG. 1 illustrates an example of a generally known exhaust system 10 for a diesel engine, including the EGR valve 12 and the ECU 14. As noted, under certain normal engine operating conditions, such as engine braking, stationary regeneration, the ECU 14 commands the EGR valve 12 to close. It is during this time, that a malfunctioning EGR valve 12, which is unable to maintain the closed position, and cannot self-diagnose and report malfunction back to the ECU. Essentially, the EGR valve 12 is being commanded closed by the ECU, and may report to the ECU that the EGR valve is open, however the self-diagnostics of the EGR valve 12 may not broadcast a fault to the ECU 14. Inability of the EGR valve 12 to self-report potential failure can lead to premature replacement of the EGR valve 12 and/or premature failures of downstream components, such as the EGR cooler 16 and the like.

The present disclosure overcomes these issues by incorporating and utilizing capabilities of the ECU 14 to monitor operation, including positioning change of the EGR valve 12 using a series of calibration values 18. FIG. 2 is a flowchart demonstrating proposed monitoring and diagnostic method of the present disclosure. Using software incorporated into the ECU 14, the ECU 14 monitors positions of the EGR valve 12, and specifically, changes and differences between actual position of the EGR valve 12 and commanded position, i.e. ECU 14 sends signal commanding position of the EGR valve 12 to the EGR valve 12 position, of the EGR valve 12.

Using a series of calibration values 18, software in the ECU 14 can determine whether there is a fault in the EGR valve 12, particularly during certain operating conditions when the EGR valve 12 is to be in commanded closed position. The series of calibration values 18 can include: differences, such as differences between an open position and a closed position, in positions of the EGR valve 12, compared with frequency and timing of change in position of the EGR valve 12. Utilizing software, the series of calibration values 18 can then be used to determine whether the EGR valve 12 position change is a normal or standard change based on normal operation thresholds. For example, in a situation where the EGR valve 12 is in an open position (actual position), when the EGR valve 12 should be in a closed position (commanded position), the series of calibration values 18 would include a threshold indicative of a faulty EGR valve 12. Thus, behavior of the EGR valve 12 can be determined in the monitoring/diagnosis method of the present disclosure based on comparison readings between a commanded position and an actual position of the EGR valve 12 during operation.

As shown in FIG. 2, while monitoring position change of the EGR valve 12, software generates a series of fault indicators 20. An example of a fault indicator may be visual reading such as “EGR fault” or, alternatively, fault may be indicated by an appropriate symbol. The series of fault indicators 20 are generated from EGR valve 12 position readings and comparisons using the series of calibration values 18. The series of fault indicators 20 are transmitted to the malfunction indicator lamp 22, otherwise known as the “Check Engine” light on a vehicle dashboard, where the fault indicators can be easily read by a driver or technician. The series of fault indicators 20 serve to identify a malfunction of the EGR valve 12 in the exhaust system 10 which then can be located and addressed, such as by a repair technician and the like.

The present diagnostic and monitoring system provides advantages of early detection of a faulty EGR valve 12, which may negatively affect engine performance, result in an increase in NOx emissions and reduced fuel efficiency. Early and accurate detection of these faults and malfunctions may lead to quicker repair, less vehicle operational downtime, and improved exhaust emissions and engine performance.

1. A method of monitoring an exhaust system of an engine having an engine control unit comprising a diagnostic module operatively associated with the engine, the method comprising the steps of:
providing an exhaust gas recirculation valve within the exhaust system;
the exhaust gas recirculation valve generating signals indicative of the valve position and sending them to the diagnostic module;
connecting the exhaust gas recirculation valve with the engine control unit;
monitoring position of the exhaust gas recirculation valve during conditions in which the exhaust gas recirculation valve is commanded to its fully closed position;
determining actual position and commanded position of the exhaust gas recirculation valve;
transmitting signals indicative of the determined actual and commanded positions of the exhaust gas recirculation valve to the diagnostic module; and using the signals indicative of the determined actual and commanded positions of the exhaust gas recirculation valve for monitoring the exhaust system of the engine and temporarily overriding the signals received by the diagnostic module from the exhaust gas recirculation valve during at least a portion of the time the exhaust gas recirculation valve is commanded to its closed position

2. The method of claim 1, wherein the conditions in which the exhaust gas recirculation valve is commanded to its fully closed position include braking and stationary regeneration.

3. The method of claim 1 further comprising the step of:
comparing the difference in signals indicative of the determined actual and commanded positions of the exhaust gas recirculation valve to a series of calibration thresholds.

4. (canceled)

5. (canceled)

6. The method of claim 3 further comprising the step of:
comparing frequency and timing of exhaust gas recirculation valve position changes with a calibrated threshold value.

7. The method of claim 6 further comprising the step of:
comparing the differences between the positions of the exhaust gas recirculation valve with the frequency and timing of change in positions.

8. The method of claim 7 further comprising the step of:
indicating a fault when the exhaust gas circulation valve is determined to be malfunctioning
